(19) United States
(12) Patent Application Publication
(10) Pub. No.: US 2018/0321576 A1
(43) Pub. Date: Nov. 8, 2018

(54) Multi-Image Blue To White Laser Conversion For Decorative Use

(71) Applicant: Seasonal Specialties, LLC, Eden Prairie, MN (US)

(72) Inventor: Steven J. Altamura, Scarsdale, NY (US)

(21) Appl. No.: 15/954,343

(22) Filed: Apr. 16, 2018

Related U.S. Application Data
(60) Provisional application No. 62/500,105, filed on May 2, 2017.

(51) Int. Cl. G03B 21/20; G03B 33/08

(52) U.S. Cl. CPC G03B 21/204; G03B 33/08

(57) ABSTRACT

To create a decorative laser that displays multiple images to provide coverage of a home, building, or shrubbery/trees, in white color, a single color laser is utilized that shines through a phosphor material to create white light, that resulting combination of phosphor excitation and laser light combines to provide white light that can be diffracted into multiple images without being split into its elemental parts.

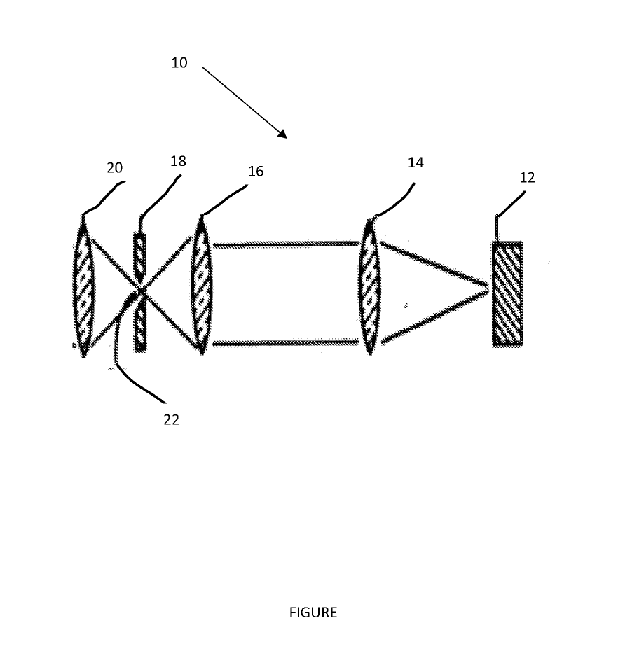

### BACKGROUND OF THE DISCLOSURE

### Field of the Disclosure

The present disclosure is directed to a use of a blue laser beam converted to white by use of a phosphor filter and to create image projection therefrom.

### Background

Decorative laser projectors currently are limited to using monochromatic lasers (single color) as they use a diffraction laser to split the projected images (which can be dots of laser light, and/or icons) into a multitude of images to provide the necessary wide angle coverage area to decorate a home, building, or tree. Typically these decorative laser projectors utilize green and/or red lasers with occasionally the use of blue lasers. Red lasers are the lowest cost, while green are much higher and blue substantially higher than the green ones. Other colors are currently cost prohibitive. White color lasers are impractical for many reasons such as cost, size, weight, etc. White, however, is the preferred color because it is capable of displaying all colors by various means.

This has precluded the use of pure white lasers in decorative projectors for several reasons. First pure white lasers (i.e. lasers which generate pure white output without combination of primary colors), do not currently exist except in the laboratory. Second, current use of “white” lasers in decorative purposes (such as in professional light laser shows, i.e. at concerts or outdoor events), are really combination lasers, which utilize the combination of red, green and blue lasers together to create a mixed beam of laser light that displays as white, such that it combines the higher cost of blue and green lasers which drives the costs beyond what is feasible for decorative lighting. Third, using 3 colors of lasers together to create white (red, green, blue), passing the light through the diffraction layer would only split the lasers back into their original colors, like that of regular light passing through a prism.

It is known to take a blue laser and pass the beam through a phosphorus filter to create white beam, but such use has been limited to light beams and not for image projection. An example of such a “flashlight” use is at http://www.wickedlasers.com/phosforce where a Phosforce™ product is sold.

### BRIEF SUMMARY

A laser system and method is disclosed to create a decorative laser that displays multiple images to provide coverage of a home, building, or shrubbery/trees, in white color, a single color laser is utilized that shines through a phosphor material to create white light, that resulting combination of phosphor excitation and laser light combines to provide white light that can be diffracted into multiple images without being split into its elemental parts.

The laser color that excites the phosphor can be in the blue wavelength.

The laser color that excites the phosphor can be in the ultraviolet wavelength.

The laser color that excites the phosphor can be in other applicable wavelengths to excite various phosphor formulations.

### DESCRIPTION OF FIGURE

The FIGURE is a schematic view of laser and lenses/filters.

### DETAILED DESCRIPTION

Decorative or holiday lighting with projectors have become very popular. In particular, displaying of images (spots, shapes, multiple-fixed images, moving images, etc.) indoors at a wall or outdoors on a window, wall or planting, creates many interesting effects.

Cost of manufacture of such projectors remains an issue as the largest market is for consumers.

Color lasers particularly red, are relatively cheap, but to create the most interesting images, a white laser is best. It can thereby display any color. Using three primary color lasers becomes cost prohibitive.

My solution to the cost problem is to use a single color laser beam modulated to project images but projected through a phosphoric filter which then converts the color to white.

To create a decorative laser that displays multiple images to provide coverage of a home, building, or shrubbery/trees, in white color, a single color laser is utilized that shines through a phosphor material to create white light, that resulting combination of phosphor excitation and laser light combines to provide white light that can be diffracted into multiple images without being split into its elemental parts.

The laser color that excites the phosphor can be in the blue wavelength.

The laser color that excites the phosphor can be in the ultraviolet wavelength.

The laser color that excites the phosphor can be in other applicable wavelengths to excite various phosphor formulations and produce different colors.

The FIGURE shows a laser and lens/filter system 10. The laser source 12 projects a beam through lenses 14, 16, and 20. More or less lenses may be used. Filter 18 is shown with split, but it may be a simple filter plate. As mentioned elsewhere the preferred filter is made of phosphoric (made of phosphor) or other color converting material.

As a method, any or all of the following steps, in any order, may be used:
a. generating a single color beam of light from a mono colored laser, preferably blue;
b. passing the beam though a phosphoric filter to generate a white beam;
c. modulating the beam to scan image patterns on a surface. This can be done by known methods for image projection systems.
d. selectively spitting the beam into separate colors according to predetermined image colors. If the image has non-white segments, a computer can selectively pass the image through a beam splitter with a shutter or other device to selectively pass 1, 2 or 3 of the primary colors at the right moment to have the image appear in the right preprogrammed color at the right moment on the screen.
e. selectively passing only the selected colors at selected times. The result is full color projection from a single color laser.

1. A method of projecting multicolored images onto a surface with a single color laser beam comprising the steps of, in any order:
a. generating a single color beam of light;
b. passing the beam though a phosphoric filter to generate a white beam;
c. modulating the beam to scan image patterns on a surface;
d. selectively spitting the beam into separate colors according to predetermined image colors;
e. selectively passing only the selected colors at selected times.
